(19) United States
(12) Patent Application Publication
(10) Pub. No.: US 2005/0277472 A1
(43) Pub. Date: Dec. 15, 2005

(54) Game server system and method for generating revenue therewith

(76) Inventors: William Gillan, Eldersburg, MD (US); Daniel Kopycienski, Tuscon, AZ (US); Wellen Sham, Hong Kong (CN)

Correspondence Address: KRAMER & AMADO, P.C., 1725 DUKE STREET, SUITE 240, ALEXANDRIA, VA, 22314, US

(21) Appl. No.: 10/396,390

(22) Filed: Mar. 26, 2003

(51) Int. Cl. G06F 17/00

(52) U.S. Cl. 463/42

(57) ABSTRACT

The present invention provides a system and method for generating revenue to a game provider from users using a gaming system. Games are provided to users by the game provider and played over the Internet or a mobile network. The system and method includes providing Internet or wireless services to the users having a computer or mobile device for playing a game. User activity is recorded by the system including the start time and end time of the game. A total game time is calculated and used as a basis for sharing revenue generated from the user's network use between the game provider and an Internet service provider or wireless network provider.

### BACKGROUND OF THE INVENTION

1. Field of the Invention

This invention relates generally to a system and method for generating revenue from an Internet service provider or a wireless network provider using a game server.

2. Description of Related Art

There are various systems and methods for serving network games to players. In a multi-player network environment, players meet in a lobby usually provided by a lobby server and choose to play a particular game with another player. Games are provided to the players with a game server in either an Internet environment with the players using computers or a mobile network environment with players using a mobile phone, portable digital assistant (PDA), or other mobile device. In most cases, a company provides the game server equipment and software in connection with a game sold to consumers in a retail market. The company may also derive revenue from advertising during game play.

In general, lobby servers are used to connect a first player with a second player. U.S. Pat. No. 6,352,479, for example, issued to Sparks, II discloses an interactive gaming server and online community forum. A multiplayer game system is implemented over the WWW using a plurality of game servers dynamically linked to and controlled by a WWW server. The WWW server dynamically links game players who log on to a web site hosted by the WWW server as a function of game playing statistics for each game player which are stored in the WWW server. The game servers generate the game player statistics for each player during and/or after game play and upload the game player statistics to the WWW server. The WWW server matches game players to appropriate games currently being played on the game servers based on the skill level required by the game and the corresponding skill levels of other current players of that game as represented by the game player statistics stored by the WWW server and dynamically generates links for the game player to the appropriate games. The user can then select which game to play by choosing one of the dynamically generated links.

U.S. Pat. No. 6,128,660, for example, issued to Grimm, et al. discloses a network match maker. A network match making system and method is used to match users of a multi-user networked application. Each user is associated with a client computer connected to the network. Clients are selected based on attributes of their users, the clients, servers, and/or communication links. The network match maker works with three different forms of network applications: peer-to-peer, multiple clients to a single server, and multiple clients to multiple servers. In one match maker method, remote server computers and client computers are matched. A match maker receives a plurality of client requests and a plurality of server requests. At least two instances of client programs and at least one instance of server programs are selected based on client and server attributes. Both U.S. Pat. Nos. 6,128,660 and 6,352,479 are herein incorporated by reference.

In general, game servers are used to provide users with instances of particular games. U.S. Pat. No. 6,203,433, for example, issued to Kume discloses a network game system, a network game server, a network game client, a player selection program, a medium storing a player selection program, and a medium storing a player information collection program. Upon receipt of a game request, a game request response unit returns player request issuance timing information specifying time to issue a player request. A player selection processing unit determines combinations of games at a predetermined timing. Upon receipt of a player request, a player request response unit extracts information about opposing players of a user issuing the player request from a user information storage unit and returns it to a client as a response to the player request. A game request unit of the client outputs a game request to a server and receives player request issuance timing information from the server. When the time specified in the player request issuance timing information is reached, a player request unit outputs a player request to the server and receives information about play partners from the server.

U.S. Pat. No. 6,152,824, for example, issued to Rothschild, et al. discloses an online gaming architecture. A networked computer online gaming system and process is arranged in a client/server online gaming architecture and utilized to run gaming programs. The client computers are configured to run a gaming client program. The server computers are coupled to the client computers via a network. The server computers run server programs including a master control program (MCP) that governs access of the server programs to the online gaming architecture, a servorum program (SV) for creating instances of a server program, a matchmaker program (MM) that supports rendezvous services, a game instances class server program (GICS) that enables games and provides user to user communication, and game upper level protocol server program (GULP) that supports the user to user communication provided by said GICS. Both U.S. Pat. Nos. 6,152,824 and 6,203,433 are herein incorporated by reference.

Providing games to mobile users on a mobile network is also shown in U.S. Pat. No. 6,453,160 issued to Thomas, et al. discloses a system for exploiting a broadcast system to enhance a wireless gaming experience using position holders to replace data. A wireless data system and a method of communicating digital data to one or more handheld wireless devices are provided. The method comprises the steps of removing at least one data segment from the digital data to form a first digital data portion and replacing the at least one data segment with an at least one position holder embedded into the first digital data portion. The method further includes forming at least one second digital data portion including the at least one data segment, communicating the first digital data portion to a wireless network, and communicating the at least one second digital data portion to a broadcast transmitter. The method broadcasts the first digital data portion from the wireless network and broadcasts the at least one second digital data portion from the broadcast transmitter. The method combines in the handheld wireless device the at least one data segment of the at least one second digital data portion into the at least one position holder of the first digital data portion to reconstitute the digital data. U.S. Pat. No. 6,453,160 is herein incorporated by reference.

The prior art shows various systems and methods for serving games to players in a multiplayer networked environment. The prior art also shows the playing of wireless and wired network games among multiple players. However, the prior art does not show a method or system for generating revenue from a gaming system other than charging users for a copy of the particular game or generating revenue from advertising.

Thus, it is an object of the present invention to provide a method for generating revenue to a game provider from users using a gaming system on a wireless network.

It is another object of the present invention to provide a system for sharing revenue generated from users of mobile devices playing games served from a game providers gaming system.

It is a further object of the present invention to provide a method for generating revenue to a game provider from users using a gaming system on the Internet.

It is a further object of the present invention to provide a system for sharing revenue generated from users of the Internet playing games served from a game provider's gaming system.

The foregoing objects and advantages of the invention are illustrative of those that can be achieved by the present invention and are not intended to be exhaustive or limiting of the possible advantages which can be realized. Thus, these and other objects and advantages of the invention will be apparent from the description herein or can be learned from practicing the invention, both as embodied herein or as modified in view of any variation which may be apparent to those skilled in the art. Accordingly, the present invention resides in the novel methods, arrangements, combinations and improvements herein shown and described.

### SUMMARY OF THE INVENTION

In light of the present need for providing a system and method for generating revenue from a gaming serving system, a brief summary of the present invention is presented. Some simplifications and omission may be made in the following summary, which is intended to highlight and introduce some aspects of the present invention, but not to limit its scope. Detailed descriptions of a preferred exemplary embodiment adequate to allow those of ordinary skill in the art to make and use the invention concepts will follow in later sections.

The present invention provides a method for generating revenue to a game provider from users using a gaming system. The method includes providing wireless services to the users, each user having a mobile device, from a wireless network provider in exchange for revenue on a cost per unit of time basis. A signal is sent from one of the mobile devices to a game server requesting a game session. A game is then initialized on the mobile device. The start time and user identification is recorded in a database of the game server. The game in then played on the mobile device. The end time is then recorded in a database of the game server. A total game time is calculated using the recorded start time and the end time. The total game time is then sent from the game server to the wireless network provider. The wireless network provider then transfers a portion of the revenue collected to the game provider based upon the total game time.

The present invention also provides a system for sharing revenue generated from users of mobile devices playing a game between a game provider and a wireless network provider. The system includes a wireless network and a game server. The game server is in communication with the mobile devices through the wireless network and includes a database for recording a start time of the game, an end time of the game and a user identification and a processor for calculating a total game time from the start time and the end time. The system also includes a billing server in communication with the game server. The billing server has a database for recording the total game time and the user identification sent from the game server. The wireless network provider collects revenue from the users for the total game time used and transfers a percentage of the revenue to the game provider.

The present invention additionally provides a method for generating revenue to a game provider from users using a gaming system. The method includes providing Internet services to the users, each user having a computer, from an Internet service provider in exchange for revenue. A signal is sent from one of the computers to a game server requesting a game session. A game is then initialized on the computer. The start time and user identification is recorded in a database of the game server. The game is then played on the computer. The end time is then recorded in a database of the game server. A total game time is calculated using the recorded start time and the end time. The total game time is then sent from the game server to the Internet service provider. The Internet service provider then transfers a portion of the revenue collected to the game provider based upon the total game time.

The present invention additionally provides a system for sharing revenue generated from users of computers playing a game between a game provider and an Internet service provider. The system includes an Internet and a game server. The game server is in communication with the computers through the Internet and includes a database for recording a start time of the game, an end time of the game and a user identification and a processor for calculating a total game time from the start time and the end time. The system also includes a billing server in communication with the game server. The billing server has a database for recording the total game time and the user identification sent from the game server. The Internet service provider collects revenue from the users for the total game time used and transfers a percentage of the revenue to the game provider.

### BRIEF DESCRIPTION OF THE DRAWINGS

In order to better understand the present invention, reference is made to the accompanying drawings, wherein:

FIG. 1 shows an overview of the gaming system.

FIG. 2 shows an overview of the lobby server and connected devices.

FIG. 3 shows a schematic view of the virtual layout of the lobby server.

FIG. 4 shows an overview of the game server and connected devices.

FIG. 5 shows an overview of the billing server and connected systems.

### DETAILED DESCRIPTION OF THE PREFERRED EMBODIMENTS OF THE INVENTION

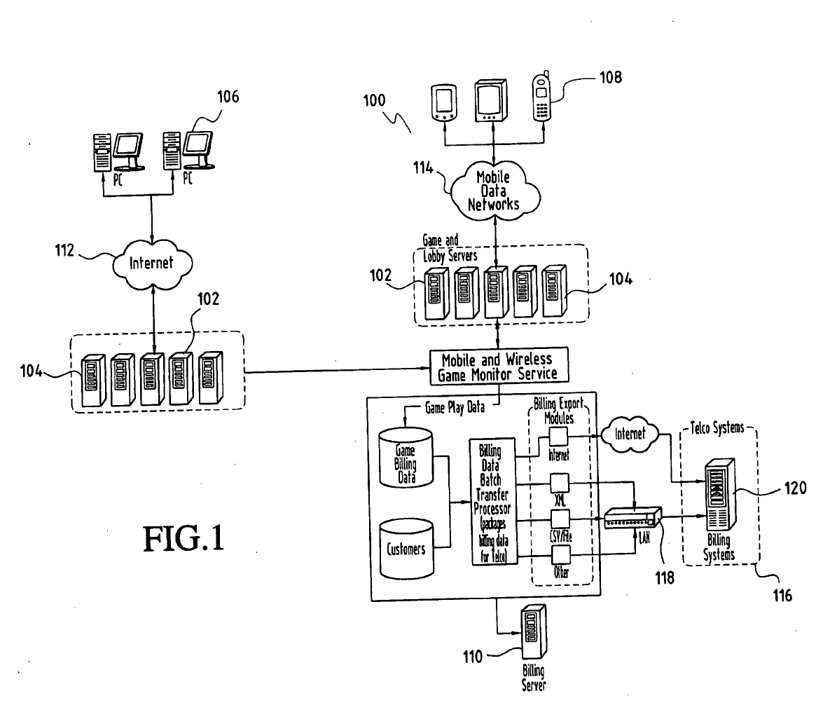

Referring now to the drawings, in which like numerals refer to like components or steps, there are disclosed broad aspects of the preferred embodiments of the present invention. The system of the present invention is a group of server applications that can be implemented on a single server or on multiple servers. FIG. 1 shows the system 100 implemented in a multi-server clustered environment. The system 100 includes one or more gaming servers 102 for a mobile data network 114 and the internet 112, one or more lobby servers 104 for a mobile data network 114 and the internet 112, and a billing server 10 connected to both the game server 102 and the billing system of the Internet service provider or mobile service provider 116 (also referenced herein as the network provider). The lobby server 104 provides the initial interaction between the mobile devices 108 operating on a mobile data network 114 (mobile devices as referenced herein means a mobile phone, tablet computer, PDA or any other device operable on a mobile network including a cellular network). The lobby server 104 also provides the initial interaction between computers 106 operating over the Internet 112. The game server 102 connects mobile devices 108 or computers 106 to one another and serves these devices game data. The billing server 110 communicates with both the game servers 102 and the billing system 120 of the network provider 116. The billing server 110 can communicate with the billing system 120 via the Internet 112 or a secured connection 118. In an alternative embodiment, the billing sever 110 can communicate with the billing system 120 via the mobile data network 114.

The server applications can be deployed inside a service provider's network or outside their internal network. The applications are scalable and are used for implementing and monitoring games played on a wired or wireless network. The system includes a game server 102, lobby server 104 (or player matching server) and a billing server 110. The game server 102 further includes a plurality of games available for download from either a mobile device 108 or a computer 106. The billing server 110 includes one or more databases for maintaining general user information, such as identification codes assigned to a particular user, user name, telephone number or IP addresses. The database or databases further provides storage for games played including a start and stop time of each game played, the particular game played or the particular game downloaded. The billing server 110 can communicate with an Internet service provider or a mobile network service provider 116.

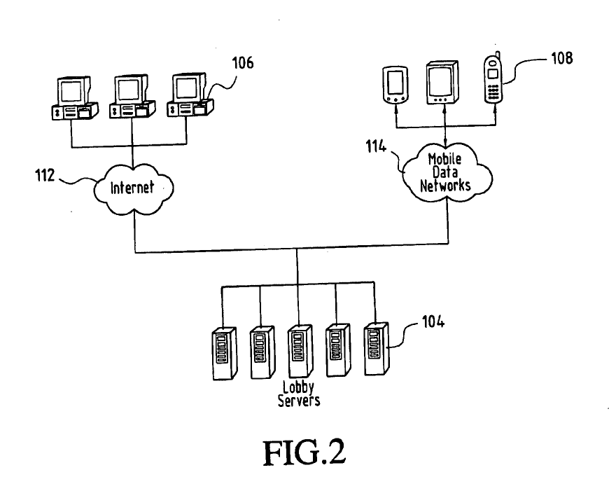

Referring now to FIG. 2, a simplified view of the lobby servers 104 and connected systems are shown. The lobby servers 104 are connected to the Internet 112 for further connection to computers 106 and a mobile data network 114 (also referred to herein as a mobile network, a wireless network or a cellular network) for further connection to mobile devices 108. The lobby server 104 runs an application that provides a virtual environment for players to meet and start multiplayer games.

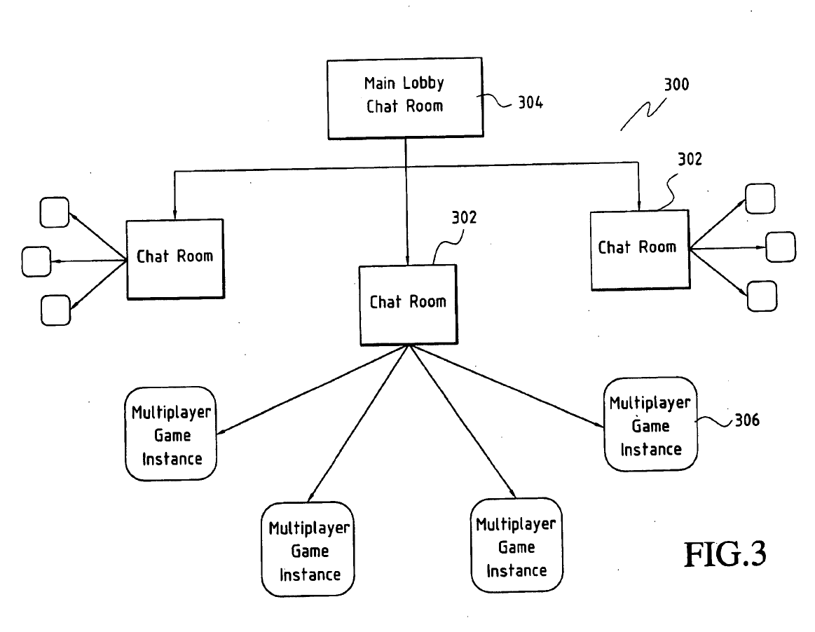

Referring now to FIG. 3, the player views the virtual environment 300 as a hierarchical structure of chat rooms 302 each associated with a particular game or game genre. It also includes a main lobby 304 where all players are initially placed. From the main lobby 304, the player can navigate to other specific chat rooms 302 to meet other players willing to play a particular game or multiplayer game instance 306. The players can chat with each other and chose to host or join a multiplayer game. The lobby server 104 can also act as a matching server. As a matching server, the lobby server 104 can automatically connect a first player with a second player automatically based upon criteria such as player ranking, high score, age, location, or any other suitable criteria for matching players. This can be done for tournament purposes, for example.

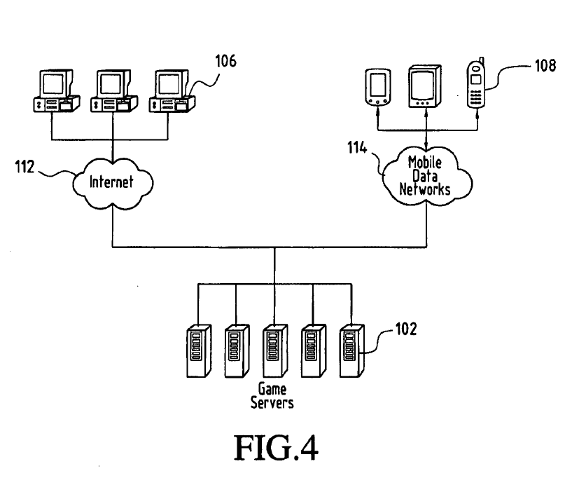

Referring now to FIG. 4, a simplified view of the game server 102 and connected components are shown. The game server 102 serves games to computers 106 and mobile devices 108 through either the Internet 112 or a mobile data network 114. The game server 102 is a server running a highly scalable Internet-enabled and mobile network enabled application that can both serve and communicate with games running on a computer 106 or mobile device 108. The gaming server 102 also communicates with the lobby server 104 and the billing server 110. (As shown in FIG. 1) The game server 102 provides game data to the games running on the computer 106 or mobile device 108. The game data includes high scores (leader board information), images, text, game level information, and other miscellaneous game content needed by the device (computer or mobile device) to play a game. The game server 102 is responsible for receiving customer and player information, game play data and player scoring data. The game server 102 can also authenticate the players. The data collected by the game server 102 can be stored in one or more databases. The game server 102 can also store a plurality of games available for download by the player.

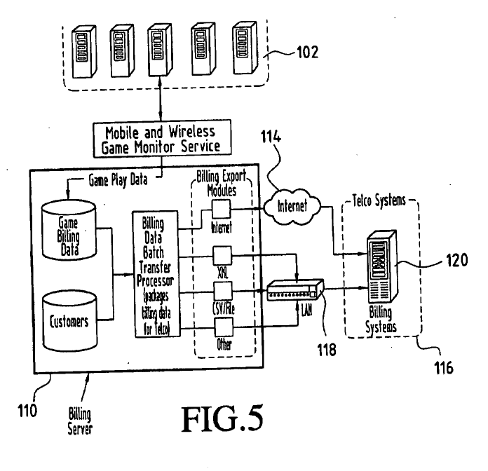

Referring now to FIG. 5, a simplified view is shown of the billing server 110 and connected systems. The billing server 110 is connected to the game server 102 and the billing system 120 of the network provider 116. The billing server 110 includes a billing database, a batch processor, and/or a real time processor and billing data export modules. The billing server 110 collects customer and game play information each time a game is played on the Internet 112 or wireless network 114 and store this in the billing database. The billing database can be implemented as a single database or multiple databases. The information can include customer identifications, game identifications, game start date and time, game end date and time, game completion status, and other optional fields required by a specific game. The information can then be retrieved directly from the game server 102 component of the system. The batch processor packages billing data for the billing data export module to send to the ISP's or mobile network provider's billing system 120. It is configured to run periodically, typically once per day, and sends the accumulated billing data for that time period to the billing data export module. In the alternative, the real time processor can package the billing data for the billing data export module. The real time processor runs continuously and sends billing data as it is received.

The billing data export module performs the task of communicating directly with the ISP or mobile network provider 116. It communicates directly with the billing system 120 of either the ISP or mobile network provider 116 and can package the data in any chosen format. The billing data export module can communicate via a secured wired connection 118, over the Internet 112, or over a wireless network 114. The security protocols used will depend on the chosen transmission medium.

Operation

The method concerns primarily the interaction between a game provider using the game server system 100 as described above and an Internet service provider or mobile network provider 116. A user or player using the Internet 112 with a computer 106 or a mobile network 114 with a network device 108, such as a PDA or cellular phone, pays for time spent on either network. The game provider and game server system 100 provides an environment and system to encourage the user or player to spend time on the network. This in turn generates revenue for the Internet service provider or the mobile network provider 116. Either provider 116 then compensates the game provider based on a percentage of the revenue generated from game playing.

Primarily the method involves providing Internet or wireless services to a user having a computer 106 or mobile device 108 in exchange for revenue on a cost per unit of time basis. The player's computer 106 or mobile device 108 sends a signal to the game server 102 requesting a game session. Once approved, a game session is initialized on the mobile device 108. The game can be a single player game. However, normally, it is a multiplayer peer-to-peer game played between users who connect with one another using the lobby server 104. The game server 102 records a start time and user identification in the database of the game server. The game is played and an end time is recorded in the database of the game server. The billing server 110 then receives the recorded information from the game server 102 and calculates a total game time using the start time and the end time. The billing server 110 then sends this information to the billing system 120 of the network provider 116. The network provider 116 in turn transfers a portion of the revenue collected to the game provider based upon the total game time.

A player of a computer 106 or mobile device 108 game first connects to the lobby server 104. The player can chat with other players in the virtual environment 300 of the lobby server 104 and find a particular player in order to initiate a game. In the alternative, a player can be matched with an additional player with the matching server. The matching server runs an application that matches players wanting to play a particular game with other players wanting to play the same game. The players can be matched based upon any criteria such as level, previous high scores, location or other stored searchable information. Once players are matched up, the host device addresses are exchanged between either the computers 106 or mobile devices 108 along with a game instance identification. The computers 106 or mobile devices 108 then contact the game server 102.

The player eventually is matched up with another player in the system. Then a game is started. The mobile device 108 or computer 106 attempts to connect to the game server 102. Upon a successful connection, the game transmits customer identification information, game start notification and any requests for additional game data to the game server 102. The game server 102 acknowledges a successful connection and login attempt and provides any additional information needed to the device. Once all game data is supplied to the user or both users the game starts and is played in a peer-to-peer manner over either the Internet 112 in the case of computers 106 or the mobile data network 114 in the case of mobile devices 108.

During game play, activity can be monitored by the game monitor service. This component retrieves or receives information from the mobile devices 108 or computers 106 playing a game. The information can include current time and status, such as whether a game is currently being played or is complete. The game server 102 can request the information from the computer 106 or mobile device 108. In the alternative, the information can be automatically sent to the game monitor service from the computer 106 or mobile device 108. This can be implemented as a message module of the game application running on the computer 106 or mobile device 108.

All information is collected and stored by the game server 102 and game monitor service in one or more databases. This information is either transmitted periodically or instantaneously to the billing server 110. In the alterative, the billing server 110 can request this information from the game server 102. The information is used to calculate the total time the user spent playing the game. The information can include the number of games played and whether the user downloaded the game for the first time. The billing server 110 then formats the information, including the calculated total time, and sends this information to the ISP's or the mobile network provider's billing system 120.

The ISP or mobile network provider 114 generates revenue by billing the user either for time used on the network or a set amount for all network use. The generated revenue is then shared with the game provider. The game provider receives a percentage of the revenue collected for the amount of time the user spends on the network. The player can also be billed for downloading and playing a particular game. For these uses, the player can be billed either directly from the game provider or indirectly through the ISP or mobile network provider.

Additionally, revenue can be generated by other actions take by the user or player. Specifically, the game provider may charge the user a set fee for initially downloading particular games. The game provider may also charge the user a set fee for each play of a particular game. The game provider may set forth in an agreement with the player that the player is to pay the game provider directly. In this case, the game provider would then send a bill directly to the user for downloading particular games and/or playing a particular game. This could be done, for example, on a pay-per-play basis. In the alternative, the network provider may bill the player for downloads or on a pay-per-play basis and transfer all or a portion of the revenue collected to the game provider.

Although the present invention has been described in detail with particular reference to preferred embodiments thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

1. A method for generating revenue to a game provider from users using a gaming system, comprising the steps of;
providing wireless services to the users, each user having a mobile device, from a wireless network provider in exchange for revenue on a cost per unit of time basis;
sending a signal from one of the mobile devices to a game server requesting a game session;
initializing a game on the mobile device;
recording a start time and a user identification in a database of the game server;
playing a game on the mobile device;
recording an end time in a database of the game server;
calculating a total game time using the start time and the end time;
sending the total game time from the game server to the wireless network provider; and
transferring a portion of the revenue collected by the wireless network provider to the game provider based upon the total game time.

2. The method of claim 1, wherein the game server has a plurality of games available for download and further comprising the step of downloading one of the games from the game server to one of the mobile devices.

3. The method of claim 2, further including the step of sending a bill to the user from the game provider for downloading one of the games.

4. The method of claim 2, further including the step of sending a bill to the user through the wireless network provider from the game provider for downloading one of the games.

5. The method of claim 2, further including the step of sending a bill to the user from the game provider for playing one of the games.

6. The method of claim 2, further including the step of sending a bill to the user from the game provider on a pay per play basis.

7. The method of claim 2, further including the step of sending a bill to the user through the wireless network provider from the game provider for playing one of the games.

8. The method of claim 2, further including the step of sending a bill to the user through the wireless network provider from the game provider on a pay per play basis.

9. The method of claim 1, further including the step of sending a signal periodically from the mobile device to the game server to notify the game server that the user is still playing the game.

10. The method of claim 9, wherein the game server further includes a game monitor component for actively monitoring the games being played on the wireless network.

11. The method of claim 10, wherein the game monitor component records the start time, the end time and the user identification in the game server database.

12. The method of claim 11, wherein the game monitor component receives the periodic signals from the mobile device for monitoring the end time of the game.

13. The method of claim 12, wherein the game monitor component includes a time out component for recording the end time of the game if no signal is received from the mobile device after a predetermined period of time.

14. A system for sharing revenue generated from users of mobile devices playing a game between a game provider and a wireless network provider, comprising:
a wireless network;
a game server in communication with the mobile devices through the wireless network and having a database for recording a start time of the game, an end time of the game and a user identification and a processor for calculating a total game time from the start time and the end time;
a billing server in communication with the game server and having a database for recording the total game time and the user identification sent from the game server; and
wherein the wireless network provider collects revenue from the users for the total game time used and transfers a percentage of the revenue to the game provider.

15. The system of claim 14, wherein the game server further includes a plurality of games available for download to the mobile devices.

16. The system of claim 14, further comprising a secure wired network for connecting the billing server to the game server.

17. The system of claim 14, wherein the game server further includes a game monitor component for actively monitoring the games being played on the wireless network.

18. The system of claim 17, wherein the game monitor component stores the user identification and the start and end times of the game in the game sever database.

19. The system of claim 17, wherein the mobile device periodically sends a signal to the game server to notify the game monitor component that the user is still playing the game.

20. The system of claim 19, wherein the game monitor component includes a time out component for recording the end time of the game if no signal is received from the mobile device after a predetermined period of time.

21. The system of claim 17, wherein the mobile device sends an end signal to the game server to notify the game monitor component that the user is finished playing the game.

22. The system of claim 14, wherein the database of the billing server further records the game played and the wireless network provider collects revenue from the users for the game played on a pay per play basis.

23. A method for generating revenue to a game provider from users using a gaming system, comprising the steps of;
providing internet services to the users, each user having a computer, from an internet service provider in exchange for revenue;
sending a signal from one of the computers to a game server requesting a game session;
initializing a game on the computer;
recording a start time and a user identification in a database of the game server;
playing a game on the computer;
recording an end time in a database of the game server;
calculating a total game time using the start time and the end time;
sending the total game time from the game server to the internet service provider; and
transferring a portion of the revenue collected by the internet service provider to the game provider based upon the total game time.

24. The method of claim 23, wherein the game server has a plurality of games available for download and further comprising the step of downloading one of the games from the game server to one of the computers.

25. The method of claim 24, further including the step of sending a bill to the user from the game provider for downloading one of the games.

26. The method of claim 24, further including the steps of sending a bill to the user through the internet service provider from the game provider for downloading one of the games.

27. The method of claim 24, further including the step of sending a bill to the user from the game provider for playing one of the games.

28. The method of claim 24, further including the step of sending a bill to the user from the game provider on a pay per play basis.

29. The method of claim 24, further including the steps of sending a bill to the user through the internet service provider from the game provider for playing one of the games.

30. The method of claim 24, further including the steps of sending a bill to the user through the internet service provider from the game provider on a pay per play basis.

31. The method of claim 23, further including the step of sending a signal periodically from the computer to the game server to notify the game server that the user is still playing the game.

32. The method of claim 31, wherein the game server further includes a game monitor component for actively monitoring the games being played on the computer.

33. The method of claim 32, wherein the game monitor component records the start time, the end time, and the user identification in the game server database.

34. The method of claim 33, wherein the game monitor component receives the periodic signals from the computer for monitoring the end time of the game.

35. The method of claim 34, wherein the game monitor component includes a time out component for recording the end time of the game if no signal is received from the computer after a predetermined period of time.

36. A system for sharing revenue generated from users of computers playing a game between a game provider and an internet service provider, comprising:
an internet;
a game server in communication with mobile devices through the internet and having a database for recording a start time of the game, an end time of the game and a user identification and a processor for calculating a total game time from the start time and the end time;
a billing server in communication with the game server and having a database for recording the total game time and the user identification sent from the game server; and
wherein the internet service provider collects revenue from the users for the total game time used and transfers a percentage of the revenue to the game provider.

37. The system of claim 36, wherein the game server further includes a plurality of games available for download from the computers.

38. The system of claim 36, further comprising a secure wired network for connecting the billing server to the game server.

39. The system of claim 36, wherein the game server further includes a game monitor component for actively monitoring the games being played on the internet.

40. The system of claim 39, wherein the game monitor component stores the user identification and the start and end times of the game in the game sever database.

41. The system of claim 39, wherein the computer periodically sends a signal to the game server to notify the game monitor component that the user is still playing the game.

42. The system of claim 41, wherein the game monitor component includes a time out component for recording the end time of the game if no signal is received from the computer after a predetermined period of time.

43. The system of claim 39, wherein the computer sends an end signal to the game server to notify the game monitor component that the user is finished playing the game.

44. The system of claim 36, wherein the database of the billing server further records the game played and the internet service provider collects revenue from the users for the game played on a pay per play basis.

45. A method of generating revenue to a game provider from users each having a mobile device within a wireless network provided by a wireless network provider, the method comprising the steps of:
determining an elapsed time of game play by each user playing a game provided by a game server on the user's mobile device;
sending the determined elapsed time of game play from the game server to the wireless network provider; and
transferring a portion of the revenue collected by the wireless network provider to the game provider based upon the total elapsed time of game play.

46. The method of generating revenue to a game provider of claim 45 wherein the game server has at least one game available for download to a mobile device within the wireless network and further comprising the step of downloading the game from the game server to the mobile device.

47. The method of generating revenue to a game provider of claim 46 further comprising the step of sending a bill to the user through the wireless network provider from the game provider for downloading the game.

48. The method of generating revenue to a game provider of claim 46 further comprising the step of sending a bill to the user through the wireless network provider from the game provider on a pay per play basis.

49. The method of generating revenue to a game provider of claim 46 further comprising the step of sending a bill from the game provider on a pay per play basis.

50. The method of generating revenue to a game provider of claim 45 wherein the game server includes a game monitor component and wherein the step of determining an elapsed time of game play by each user playing a game includes recording a start time, an end time and a user identification for each game play within the game server.

51. A system for sharing revenue generated from users of mobile devices within a wireless network playing a game between a game provider and a wireless network provider, the system comprising:
a game server in communication with a plurality of mobile devices within the wireless network having a database for recording a start time of each game, an end time of the game and a user identification identifying the user; and
means for calculating a total elapsed game time derived from the start time and the end time;
wherein the wireless network provider collects revenue from the users for the total elapsed game time used and transfers a percentage of the revenue to the game provider.

52. The system for sharing revenue generated from users of mobile devices of claim 51 further comprising a billing server in communication with the game server and having a database for recording the total game time and the user identification sent from the game server for each game played by a user.

53. The system for sharing revenue generated from users of mobile devices of claim 52 wherein the billing server communicates with a billing system of the wireless network provider for billing the user for game play from the game server, the billing server providing information on game play and user identification to the billing system.

54. The system for sharing revenue generated from users of mobile devices of claim 51 wherein the game server includes a plurality of games for download to the mobile devices.

55. The system for sharing revenue generated from users of mobile devices of claim 51 wherein the game server includes a game monitor component for actively monitoring the games being played on the wireless network.

56. The system for sharing revenue generated from users of mobile devices of claim 55 wherein the mobile device playing a game periodically sends a signal to the game server to notify the game monitor component that the user is still playing the game.

57. The system for sharing revenue generated from users of mobile devices of claim 55 wherein the game monitor component includes a time out component for recording the end time of the game if no signal is received from the mobile device after a predetermined period of time.

58. A method of generating revenue to a game provider from users each having a computer receiving internet services provided by an internet service provider, the method comprising the steps of:
determining an elapsed time of game play by each user playing a game provided by a game server on the user's computer;
sending the determined elapsed time of game play from the game server to the internet service provider; and
transferring a portion of the revenue collected by the internet service provider to the game provider based upon the total elapsed time of game play.

59. The method of generating revenue to a game provider of claim 58 wherein the game server has at least one game available for download to a computer and further comprising the step of downloading the game from the game server to the computer.

60. The method of generating revenue to a game provider of claim 59 further comprising the step of sending a bill to the user through the internet service provider from the game provider for downloading the game.

61. The method of generating revenue to a game provider of claim 59 further comprising the step of sending a bill to the user through the internet service provider from the game provider on a pay per play basis.

62. The method of generating revenue to a game provider of claim 59 further comprising the step of sending a bill from the game provider on a pay per play basis.

63. The method of generating revenue to a game provider of claim 58 wherein the game server includes a game monitor component and wherein the step of determining an elapsed time of game play by each user playing a game includes recording a start time, an end time and a user identification for each game play within the game server.

64. A system for sharing revenue generated from users of computers receiving internet services provided by an internet service provider playing a game between a game provider and the internet service provider, the system comprising:
a game server in communication with a plurality of computers connected to the internet having a database for recording a start time of each game, an end time of the game and a user identification identifying the user; and
means for calculating a total elapsed game time derived from the start time and the end time;
wherein the internet service provider collects revenue from the users for the total elapsed game time used and transfers a percentage of the revenue to the game provider.

65. The system for sharing revenue generated from users of computers of claim 64 further comprising a billing server in communication with the game server and having a database for recording the total game time and the user identification sent from the game server for each game played by a user.

66. The system for sharing revenue generated from users of computers of claim 65 wherein the billing server communicates with a billing system of the internet service provider for billing the user for game play from the game server, the billing server providing information on game play and user identification to the billing system.

67. The system for sharing revenue generated from users of computers of claim 64 wherein the game server includes a plurality of games for download to the computers.

68. The system for sharing revenue generated from users of computers of claim 64 wherein the game server includes a game monitor component for actively monitoring the games being played.

69. The system for sharing revenue generated from users of computers of claim 68 wherein the computer playing a game periodically sends a signal to the game server to notify the game monitor component that the user is still playing the game.

70. The system for sharing revenue generated from users of computers of claim 69 wherein the game monitor component includes a time out component for recording the end time of the game if no signal is received from the computer after a predetermined period of time.
